(19) United States
(12) Patent Application Publication
(10) Pub. No.: US 2015/0107896 A1
(43) Pub. Date: Apr. 23, 2015

(54) COAXIAL CABLE HAVING END TERMINAL AND METHOD OF MANUFACTURING THE SAME

(71) Applicant: YAZAKI CORPORATION, Tokyo (JP)

(72) Inventors: Hajime Kato, Kakegawa-shi (JP); Kazuhiro Tomine, Kakegawa-shi (JP); Takaaki Miyajima, Kakegawa-shi (JP)

(21) Appl. No.: 14/397,991

(22) PCT Filed: May 2, 2013
(86) PCT No.: PCT/JP2013/063226

§ 371 Date: Oct. 30, 2014

(30) Foreign Application Priority Data
May 2, 2012 (JP) 2012-105448

(51) Int. Cl. H01R 43/048; H01R 9/05

(52) U.S. Cl. CPC H01R 43/048; H01R 9/0518
USPC 174/74 R; 29/828

(57) ABSTRACT

A method of manufacturing a coaxial cable having an end terminal includes exposing one end portions of twisted wires from a coaxial cable having an inner conductor, an inner insulator wrapping a periphery of the inner conductor, a plurality of twisted wires spirally wound onto an outer periphery of the inner insulator and an outer insulator wrapping a periphery of the twisted wires, radially unfolding the one end portions of the twisted wires, fitting the one end portions of the twisted wires between an inner cylindrical end terminal having a cylindrical shape and an annular ring, and caulking the ring to connect the one end portions of the twisted wires to the annular ring.

### TECHNICAL FIELD

The invention relates to a coaxial cable having an end terminal and a method of manufacturing the same.

### BACKGROUND ART

When connecting a coaxial cable to a mating end terminal (hereinafter, abbreviated as an end terminal), the coaxial cable is subject to terminal processing. For example, a coaxial cable may be configured so that an inner insulator wraps a periphery of an inner conductor, a braided wire, which is an outer conductor, wraps a periphery of the inner insulator and an outer insulator wraps a periphery of the braided wire. When performing the terminal processing of the coaxial cable, one end of the outer insulator is stripped to expose a terminal of the outer conductor and one end of the inner insulator is stripped to expose a terminal of the inner conductor.

PTL 1 discloses a method of connecting a coaxial cable (shield electric wire) to an end terminal having a cylindrical shape. In the coaxial cable inserted into a hole of the end terminal, the exposed braided wire is folded onto an outer periphery of the end terminal from a cylindrical end surface of the end terminal and an annular ring is fitted onto the folded braided wire. Then, the ring is caulked to crimp the braided wire to the outer periphery of the end terminal, so that the coaxial cable and the end terminal are electrically connected.

According to the shield electric wire of PTL 1, the outer conductor consists of the braided wire that is formed by braiding conductive wires into a net shape. Among the coaxial cables, there is a coaxial cable in which a plurality of electric wires is spirally wound along the outer periphery of the inner insulator, instead of the braided wire. The electric wires are respectively twisted into a spiral shape to thus form a bundle of the plurality of electric wires (hereinafter, referred to as twisted wires), thereby configuring the outer conductor. The twisted wires are arranged side by side in a circumferential direction along the outer periphery of the inner insulator.

Regarding a method of connecting the coaxial cable, in which the outer conductor consists of the plurality of twisted wires, to the end terminal, a method as shown in FIG. 2 may be considered, for example.

First, as shown in FIG. 2A, a coaxial cable 51 having a processed terminal is prepared. In the coaxial cable 51, an inner conductor 53, an inner insulator 55 and an outer conductor 55 (twisted wires 57) are exposed in order from a terminal-side thereof Then, as shown in FIG. 2B, end portions of the exposed twisted wires 57 are radially unfolded and a cylindrical end terminal 59 mounted from the terminal-side of the coaxial cable 51 is positioned at an inside of the twisted wires 57.

Then, as shown in FIG. 2C, an annular ring 61, which has been mounted onto the coaxial cable 51 in advance, is slid to the terminal-side, so that the ring is mounted to wrap the end terminal 59 while pressing the twisted wires 57 along an outer periphery of the end terminal 59. Thereby, the twisted wires 57 are interposed between the outer periphery of the end terminal 59 and an inner periphery of the ring 61. At last, as shown in FIG. 2D, the ring 61 is caulked from the outer periphery thereof, so that the twisted wires are interposed and pressed between the end terminal 59 and the ring 61.

### CITATION LIST

### Patent Literature

PTL1: JP-A-2002-218622

### SUMMARY OF INVENTION

### Technical Problem

However, the twisted wires exposed from the terminal of the coaxial cable are spirally twisted. Hence, as shown in FIGS. 3A and 3B, when the twisted wires 57 are radially unfolded, each twisted wire 57 extends with being spirally twisted. Therefore, when the ring is fitted to wrap the bundle of the twisted wires 57 radially unfolded, since the extension direction of the twisted wires and the ring fitting direction are different from each other, the twisted wires 57 may overlap with each other at the inside of the ring, as shown in FIG. 4. When the twisted wires overlap with each other, the fitting ability of the ring is deteriorated. Also, a sectional area of a connection part of the end terminal and the coaxial cable becomes non-uniform in the circumferential direction, so that an electric resistance may be increased.

An object of the invention is to prevent twisted wires from overlapping with each other when connecting an end terminal to a terminal of a coaxial cable.

### Solution to Problem

(1) According to an aspect of the invention, a method of manufacturing a coaxial cable having an end terminal includes exposing one end portions of twisted wires from a coaxial cable having an inner conductor, an inner insulator wrapping a periphery of the inner conductor, a plurality of twisted wires spirally wound onto an outer periphery of the inner insulator and an outer insulator wrapping a periphery of the twisted wires, radially unfolding the one end portions of the twisted wires, fitting the one end portions of the twisted wires between an inner cylindrical end terminal having a cylindrical shape and an annular ring, and caulking the ring to connect the one end portions of the twisted wires to the annular ring. In the unfolding step, while pressing root portions of exposed parts of the one end portions of the twisted wires with a jig, the coaxial cable is rotated about an axis of the coaxial cable in an opposite direction to a twisted direction of the twisted wires, or the jig is rotated about the axis of the coaxial cable in the twisted direction of the twisted wires to correct a twisted state of the exposed twisted wires.

Like this, while pressing the root portions of the exposed parts of the twisted wires, any one of the coaxial cable and the jig is rotated in a predetermined direction. Hence, it is possible to correct the twisted state of the twisted wires while radially unfolding a bundle of the twisted wires. Thereby, when fitting the ring, it is possible to prevent positional deviation of the twisted wires, which is caused due to a deviation between an extension direction of the twisted wires and a ring mounting direction. Hence, it is possible to prevent the twisted wires from overlapping with each other.

(2) According to another aspect of the invention, a coaxial cable having an end terminal includes a coaxial cable that has an inner conductor, an inner insulator wrapping a periphery of the inner conductor, a plurality of twisted wires spirally wound onto an outer periphery of the inner insulator and an outer insulator wrapping a periphery of the twisted wires, one end portions of the twisted wires being exposed, an inner cylindrical end terminal that has a cylindrical shape and is arranged at an inside of the exposed twisted wires, and an annular ring that is caulked in a state where the annular ring wraps the one end portions of the twisted wires arranged on an outer periphery of the inner cylindrical end terminal. The twisted wires are fitted and pressed between the inner cylindrical end terminal and the ring in a state where a twisted state of the twisted wires is changed to an untwisted state and the untwisted wires extend in an axial direction of the coaxial cable.

In the coaxial cable having an end terminal configured as described above, the twisted wires are arranged without overlapping with each other. Thereby, a sectional area of a connection part of the coaxial cable and the end terminal becomes uniform in the circumferential direction, so that it is possible to suppress an increase in an electrical resistance.

### Advantageous Effects of Invention

According to the invention, it is possible to prevent the twisted wires from overlapping with each other when connecting the end terminal to the terminal of the coaxial cable.

### BRIEF DESCRIPTION OF DRAWINGS

FIGS. 1A to 1F illustrate a method of assembling a coaxial cable having an end terminal according to an illustrative embodiment of the invention.

FIGS. 2A to 2D illustrate a method of assembling a coaxial cable having an end terminal according to the related art.

FIGS. 3A and 3B show a state of twisted wires when the twisted wires are unfolded according to the related art.

FIG. 4 shows a state where the twisted wires overlap with each other at an inside of a ring.

### DESCRIPTION OF EMBODIMENTS

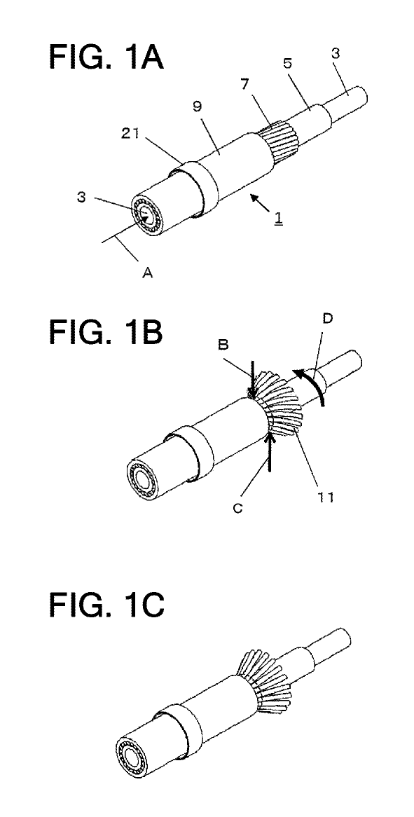

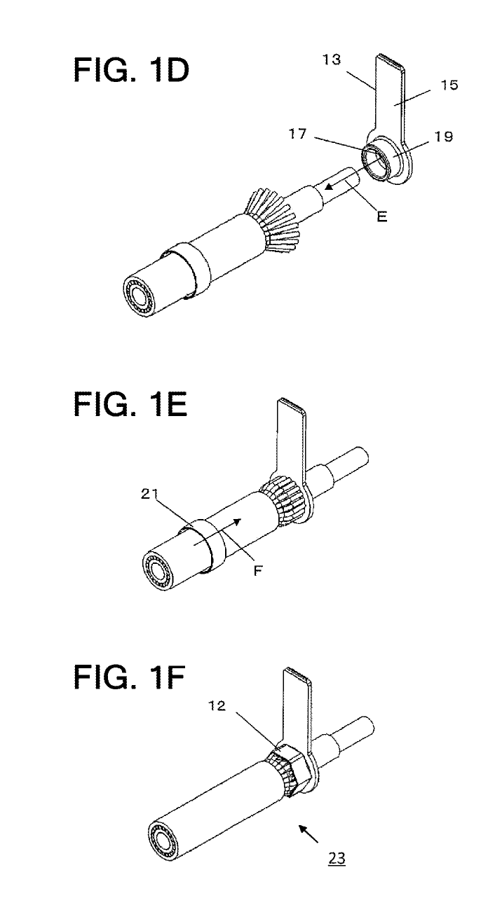

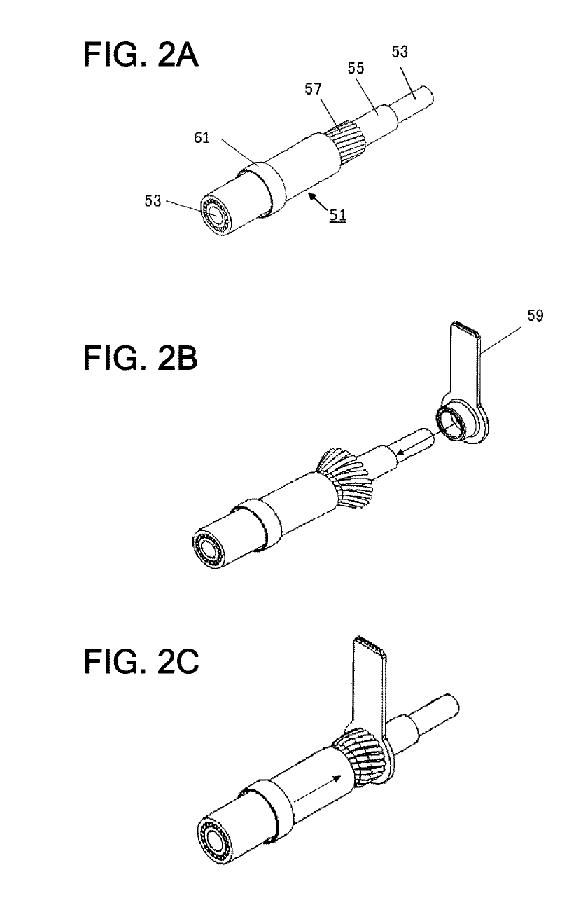

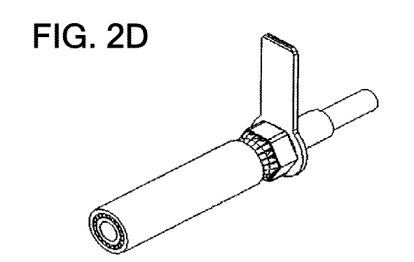

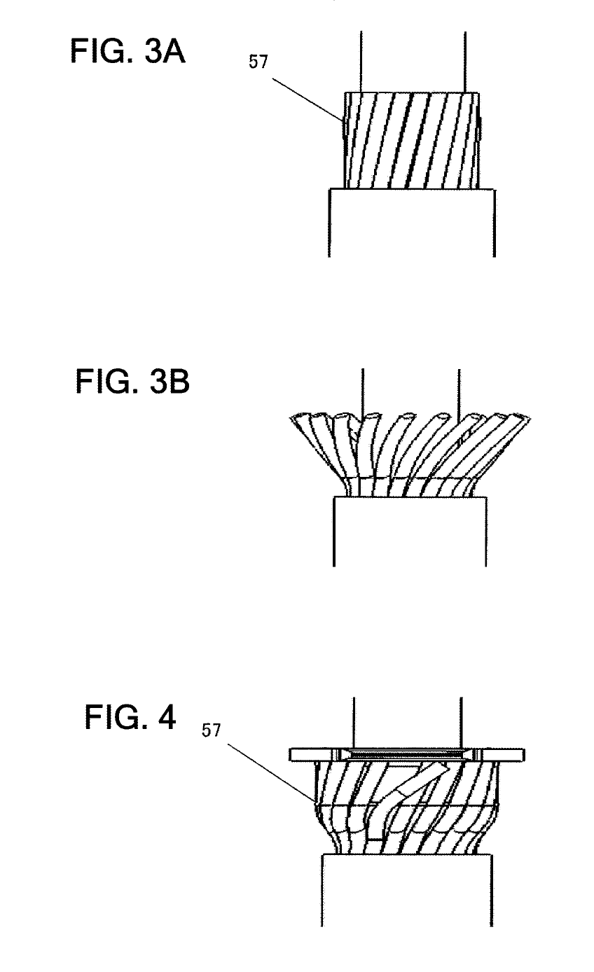

Hereinafter, an illustrative embodiment of a coaxial cable having an end terminal of the invention will be described with reference to the drawings. FIGS. 1A to 1F show a configuration of a coaxial cable having an end terminal of this illustrative embodiment (FIG. 1F) and a method of manufacturing the same (FIGS. 1A to 1F). In the meantime, the reference numerals shown in FIG. 1A are omitted in FIGS. 1B to 1F.

As shown in FIG. 1A to 1F, a coaxial cable 1 that is used in this illustrative embodiment includes an inner conductor (core wire) 3, an inner insulator 5 that extends in a longitudinal direction while wrapping a periphery of the inner conductor 3, an outer conductor 7 that extends in a longitudinal direction while wrapping a periphery of the inner insulator 5 and an outer insulator 9 (sheath) that extends in a longitudinal direction while wrapping a periphery of the outer conductor 7.

The outer conductor 7 consists of a plurality of twisted wires 11 that is wound into a spiral shape along an outer periphery of the inner insulator 5. In this illustrative embodiment, the twisted wires 11 are arranged side by side in a line without a gap in a circumferential direction along the outer periphery of the inner insulator 5. In the meantime, as shown in FIG. 1A, the twisted wires 11 are spirally wound in a clockwise direction on the outer periphery of the inner insulator 5, when seen from an arrow A direction along an axis of the inner conductor 3.

In order to connect the coaxial cable 1 to an end terminal 13, a terminal of the coaxial cable is subject to terminal processing. That is, one end of the outer insulator 9 is stripped to expose a terminal of the outer conductor 7 and one end of the inner insulator 5 is stripped to expose a terminal of the inner conductor 3. As shown in FIG. 1A, in the coaxial cable 1 having the processed terminal, the inner conductor 3, the inner insulator 5 and the outer conductor 7 are exposed in order from the terminal thereof. In this illustrative embodiment, the outer conductor 7 of the coaxial cable 1 having the processed terminal is connected to the end terminal 13.

As shown in FIG. 1D, the end terminal 13 includes an end terminal body 15 having a flat plate shape, a circular through-hole 17 that is formed at one end of the end terminal body 15 and an inner cylindrical part 19 that is projected to have a cylindrical shape from a circumferential edge of the through-hole 17. The through-hole 17 and the inner cylindrical part 19 have an inner diameter (hole diameter) into which the inner insulator 5 exposed from the terminal of the coaxial cable 1 can be inserted, respectively. Also, the inner cylindrical part 19 has an outer diameter larger than that of the outer insulator 9.

An annular ring 21 is mounted onto the coaxial cable 1 so that it wraps the outer insulator 9. The ring 21 has an inner diameter larger than the outer diameter of the outer insulator 9 of the coaxial cable 1 and is mounted so that it can be slid along the outer insulator 9 of the coaxial cable 1.

In the below, a method of connecting the end terminal 13 to the coaxial cable 1 is described. First, as shown in FIG. 1A, the coaxial cable 1 that has been subject to the terminal processing is prepared and the ring 21 is fitted onto the coaxial cable 1.

Subsequently, the twisted wires 11 are radially unfolded so as to position the inner cylindrical part 19 of the end terminal 13 at an inside of the twisted wires 11. At this time, when the twisted wires 11 are merely radially unfolded, the twisted wires are spirally twisted, so that the twisted wires 11 may overlap with each other when the ring 21 is fitted, as described below (refer to FIG. 4).

Hence, in this illustrative embodiment, as shown in FIG. 1B, while root portions of the exposed parts of the twisted wires 11 are pressed in predetermined directions and with predetermined forces by using dedicated jigs from arrows B, C directions (for example, 180° phase-deviated positions, for example), the coaxial cable 1 is rotated about an axis thereof in an arrow D direction, which is opposite to the twisted direction of the twisted wires 11, at predetermined speed. The rotating operation may be mechanically performed while axially supporting the coaxial cable 1.

As a result, as shown in FIG. 1C, the bundle of the twisted wires 11 is radially unfolded about the axis of the coaxial cable 1 and the twisted state of the twisted wires 11 is also corrected. That is, it is possible to remove the spirally twisted state of the twisted wires 11 by appropriately regulating the conditions such as pressing directions and pressing forces of the jigs, rotating speed of the coaxial cable 1 and the like.

Then, as shown in FIG. 1D, the inner cylindrical part 19 of the end terminal 13 is fitted onto the coaxial cable 1 from the terminal thereof in an arrow E direction and is positioned at the inside of the radially unfolded twisted wires 11. At this time, an inner periphery of the inner cylindrical part 19 is arranged at a position facing the inner insulator 5 of the coaxial cable 1.

Then, as shown in FIG. 1E, the ring 21 is slid in an arrow F direction along the coaxial cable 1, is press-fitted to wrap the twisted wires 11 and is thus fitted onto the inner cylindrical part 19.

Here, as the ring 21 is fitted, the twisted wires 11 are deformed so that they are press-fitted along the outer periphery of the inner cylindrical part 19. However, since the twisted state has been already corrected, there is little deviation between the press-fitting direction of the ring 21 and the extension direction of the twisted wires 11. Hence, the twisted wires 11 are press-fitted by the ring 21 without causing torsion. That is, the twisted wires 11 are disposed at the inside of the ring 21 with extending in the axial direction of the coaxial cable 1 without overlapping with each other.

At the state where the twisted wires 11 are interposed between the inner periphery of the ring 21 and the outer periphery of the inner cylindrical part 19, the ring 21 is caulked, as shown in FIG. 1F, so that the twisted wires 11 are interposed and pressed between the ring 21 and the inner cylindrical part 19. Thereby, a coaxial cable 23 having an end terminal in which the coaxial cable 1 and the end terminal 13 are electrically connected to each other is obtained.

In the coaxial cable 23 having an end terminal manufactured in this illustrative embodiment, the twisted wires 11 interposed between the ring 21 and the inner cylindrical part 19 are extended in the axial direction of the coaxial cable 1, so that the twisted wires 11 are interposed and pressed between the ring 21 and the inner cylindrical part 19 without overlapping with each other. Thereby, since a sectional area of a connection part of the end terminal and the coaxial cable becomes uniform in the circumferential direction, it is possible to suppress an increase in the electrical resistance.

Also, according to the method of manufacturing the coaxial cable having an end terminal of this illustrative embodiment, when unfolding the bundle of the twisted wires 11, the coaxial cable 1 is rotated while pressing the jigs to the exposed twisted wires 11. Thus, even when the twisted wires 11 are twisted in a predetermined direction, it is possible to easily unfold the twisted wires and to correct the twisted state of the twisted wires 11. Thereby, for example, it is possible to prevent the twisted wires 11 from overlapping with each other, which is caused due to the deviation between the extension direction of the twisted wires 11 and the mounting direction of the ring 21 when fitting the ring 21. Hence, it is possible to suppress an increase in the resistance upon the mounting of the ring 21, so that it is possible to increase the efficiency of the mounting operation of the ring 21.

Also, in this illustrative embodiment, when unfolding the bundle of the twisted wires 11, while the root portions of the exposed parts of the twisted wires 11 are pressed by the jigs, the coaxial cable 1 is rotated about the axis thereof in the opposite direction to the twisted direction of the twisted wires 11. That is, the coaxial cable 1 has only to rotate relative to the jigs in the opposite direction to the twisted direction of the twisted wires 11. Instead of the method of this illustrative embodiment, even when the coaxial cable 1 is fixed and the jigs are rotated about the axis of the coaxial cable 1 in a circumferential direction (clockwise direction, when seen from the arrow A direction) corresponding to the twisted direction of the twisted wires 11 while the root portions of the exposed parts of the twisted wires 11 are pressed by the jigs, the same effects can be obtained.

Although the illustrative embodiment of the invention has been specifically described, the above illustrative embodiment is only exemplary and the invention is not limited to the configuration of the above illustrative embodiment. The design can be changed without departing from the gist of the invention, which is also included in the invention.

For example, in the above illustrative embodiment, when unfolding the bundle of the twisted wires 11, the jigs are pressed to two places (180° phase-deviated positions) of the exposed parts of the twisted wires 11. However, the number of the jigs pressing the twisted wires 11, the provision interval of the jigs in the circumferential direction and the like are not limited thereto and may be appropriately changed.

The present application is based on Japanese Patent Application No. 2012-105448, filed on May 2, 2012, the entire contents of which are incorporated herein by reference.

### INDUSTRIAL APPLICABILITY

According to the exemplary embodiment, it is possible to prevent the twisted wires from overlapping with each other when connecting the end terminal to the terminal of the coaxial cable.

### REFERENCE SIGNS LIST

1: coaxial cable
3: inner conductor (core wire)
5: inner insulator
7: outer conductor
9: outer insulator
11: twisted wire
13: end terminal
19: inner cylindrical part
21: ring
23: coaxial cable having an end terminal

1. A method of manufacturing a coaxial cable having an end terminal, the method comprising:
exposing one end portions of twisted wires from a coaxial cable having an inner conductor, an inner insulator wrapping a periphery of the inner conductor, a plurality of twisted wires spirally wound onto an outer periphery of the inner insulator and an outer insulator wrapping a periphery of the twisted wires;
radially unfolding the one end portions of the twisted wires;
fitting the one end portions of the twisted wires between an inner cylindrical end terminal having a cylindrical shape and an annular ring; and
caulking the ring to connect the one end portions of the twisted wires to the annular ring,
wherein, in the unfolding step, while pressing root portions of exposed parts of the one end portions of the twisted wires with a jig, the coaxial cable is rotated about an axis of the coaxial cable in an opposite direction to a twisted direction of the twisted wires, or the jig is rotated about the axis of the coaxial cable in the twisted direction of the twisted wires to correct a twisted state of the exposed twisted wires.

2. A coaxial cable having an end terminal comprising:
a coaxial cable that has an inner conductor, an inner insulator wrapping a periphery of the inner conductor, a plurality of twisted wires spirally wound onto an outer periphery of the inner insulator and an outer insulator wrapping a periphery of the twisted wires, one end portions of the twisted wires being exposed;
an inner cylindrical end terminal that has a cylindrical shape and is arranged at an inside of the exposed twisted wires; and
an annular ring that is caulked in a state where the annular ring wraps the one end portions of the twisted wires arranged on an outer periphery of the inner cylindrical end terminal,
wherein the twisted wires are fitted and pressed between the inner cylindrical end terminal and the ring in a state where a twisted state of the twisted wires is changed to an untwisted state and the untwisted wires extend in an axial direction of the coaxial cable.
